(19) United States
(12) Patent Application Publication
(10) Pub. No.: US 2025/0128785 A1
(43) Pub. Date: Apr. 24, 2025

(54) Drive Arrangement for a Bicycle

(71) Applicant: ZF Friedrichshafen AG, Friedrichshafen (DE)

(72) Inventors: Finn Neumann, Ravensburg (DE); Kevin Holder, Meckenbeuren (DE)

(21) Appl. No.: 18/925,855

(22) Filed: Oct. 24, 2024

(30) Foreign Application Priority Data
Oct. 24, 2023 (DE) 102023210476.8

(51) Int. Cl. B62M 6/50; B62J 45/20; B62J 45/41

(52) U.S. Cl. CPC B62M 6/50; B62J 45/20; B62J 45/41

(57) ABSTRACT

A drive arrangement for a bicycle includes a detent freewheel mechanism (14). The detent freewheel mechanism (14) has a first ring (20) with detents (24), which are movably supported thereon, and a second ring (22) having a tooth arrangement (26). In addition, the drive arrangement has at least one sensor apparatus, which is configured to detect a deformation of the first ring (20) of the detent freewheel mechanism (14) on the basis of a drive force which is applied. The sensor apparatus (24) has one associated deformation sensor (28) in each case per detent (24).

### CROSS-REFERENCE TO RELATED APPLICATION

The present application is related and claims priority to DE102023210476.8, which was filed in the German Patent Office on Oct. 24, 2024 and is incorporated by reference herein in its entirety.

### TECHNICAL FIELD

The present invention relates generally to a drive arrangement for a bicycle. In addition, the present invention relates generally to a method for operating a drive arrangement of a bicycle and a bicycle.

### BACKGROUND

In bicycles it is known to provide a freewheel mechanism. Consequently, for example, a foot pedal shaft can be decoupled from a driven running wheel. The bicycle can thus travel without respective pedals of the bicycle rotating. In Pedelecs, for example, using a freewheel mechanism, a drive motor can also be decoupled. In a blocking state, however, the freewheel mechanism can connect two shafts to each other in a rotationally secure manner in order, for example, to enable a transmission of drive force.

By detecting a deformation of a component of the freewheel mechanism, the transmitted drive force can be detected in this case, for example, in order to control a drive. However, depending on the structure of the freewheel mechanism and a relative position in which the two shafts were connected to each other, there may occur disturbance variables. For example, in the blocking state, a radial force which deforms the freewheel mechanism regardless of a blocking state position may act on the freewheel mechanism. Depending on the production tolerances and wear, respective detents of the freewheel mechanism may also engage differently with a tooth arrangement in the blocking state. Disturbance variables which do not correspond directly to the transmitted drive force can also be caused thereby. Accordingly, the detected deformation may correspond only imprecisely to the transmitted drive force.

DE 10 2012 100 682 A1 describes a torque sensor and a freewheel mechanism which has a first rotation element by which a torque which is intended to be determined can be transmitted to a second rotation element which is coaxial with the first rotation element in one rotation direction. In addition, a device for establishing a rotation of the first rotation element against the second rotation element in the rotation direction mentioned and for determining the torque with respect to the established rotation is described. The torque determination is thus very complex.

### BRIEF SUMMARY

A first example aspect relates to a drive arrangement for a bicycle. The drive arrangement may, for example, have a gear mechanism, a foot pedal shaft, a running wheel and respective force transmission elements to the running wheel. The drive arrangement may have a drive motor, for example, in the form of an electric motor. The drive arrangement may be configured for a bicycle which is in the form of a Pedelec. The drive arrangement may be configured to transmit a drive force from a bicycle rider and optionally from the drive motor to the running wheel.

The drive arrangement has a detent freewheel mechanism. A detent freewheel mechanism is also referred to as a blocking detent freewheel mechanism. A freewheel mechanism may, for example, transmit torque in only one rotation direction, wherein the freewheel mechanism is then in the blocking state thereof. In the case of a relative reversal of rotation direction, however, a connection is in contrast independently released, whereby the freewheel mechanism is then in the release state thereof. In the blocking state, the respective detents of the detent freewheel mechanism may be in engagement. In the release state, however, the detents of the detent freewheel mechanism, for example, slide off. The detent freewheel mechanism may, for example, be configured to decouple a drive, such as a foot pedal shaft, from an output. For example, the detent freewheel mechanism may also decouple the foot pedal shaft from the drive motor or the drive motor from the foot pedal shaft. The detent freewheel mechanism may also be configured to change a gear in the gear mechanism of the drive arrangement.

The detent freewheel mechanism has at least a first ring and a second ring. The two rings may be permanently connected in each case in a rotationally secure manner to a shaft of the drive arrangement. The rings may also form a disc. For example, a ring which is in the form of an inner ring having a radially extending wall may be connected to a shaft in a rotationally secure manner. The rings may also have non-annular part-regions, recesses and alternatively or additionally decentralised through-openings.

The second ring has a tooth arrangement. The tooth arrangement may, for example, extend along a circumference of the second ring radially at the inner side or at the outer side. The tooth arrangement may be configured for engagement via the detents. The tooth arrangement may have tooth tips which protrude in the direction of the first ring and valleys located between.

The detent freewheel mechanism has detents which are movably supported on the first ring. The detent freewheel mechanism may have a large number of these detents, for example, two, three, four or more detents. As a result of more detents, a higher torque may be able to be transmitted. The detents may also be referred to as locking detents. The detents may, for example, at an end facing the second ring, in each case be pivotably supported about an associated axial rotation axis on the first ring. The detents are, for example, in a blocking state of the detent freewheel mechanism in engagement with the tooth arrangement of the second ring. The detents may with regard to the engagement, for example, be resiliently pretensioned. In a release state, the engagement of the detents with the tooth arrangement is cancelled. In the blocking state, the two rings are connected to each other in a rotationally secure manner by the engagement. In the release state, the detents slide off, for example, on the tooth arrangement and the two rings can rotate relative to each other in one rotation direction. The detents may, for example, enable a rotation of the two rings with respect to each other in one rotation direction and in an opposite rotation direction prevent engagement of the detent with the tooth arrangement. The detents and the tooth arrangement may be arranged at mutually facing sides of the two rings.

The two rings may be arranged coaxially with respect to each other. The two rings may be arranged in the same axial region. The two rings may in each case be rotatably supported about a centre axis. For example, one of the two rings is permanently connected in a rotationally secure manner to an input shaft of the detent freewheel mechanism or a shaft of the drive arrangement. For example, another of the two rings is permanently connected in a rotationally secure manner to an output shaft of the detent freewheel mechanism or a shaft of the drive arrangement.

The drive arrangement has a sensor apparatus which is configured to detect a deformation of the first ring of the detent freewheel mechanism on the basis of an applied drive force. The drive force may, for example, be transmitted to the second ring in the blocking state or be transmitted from the second ring to the first ring in the blocking state. The drive force can be introduced into the drive arrangement, for example, by a rider of the bicycle at respective pedals. Additionally or alternatively, the drive force can be introduced into the drive arrangement by the drive motor. The detected deformation may, for example, allow a statement concerning a transmitted torque. The applied drive force may correspond to the transmitted torque. As a result of the detection, for example, a power measurement, an automatic control of a gear shift of the bicycle and, alternatively or additionally, a control of the drive motor in accordance with the drive force applied at the detent freewheel mechanism may be possible. The control can also be carried out directly in accordance with the detected deformation. Additional functions can also be based on this detection, such as determining wear of the detent freewheel mechanism.

The sensor apparatus has one associated deformation sensor per detent in each case. Each deformation sensor is, for example, configured to detect the deformation in a measurement region, for example, beside or on the associated detent. As a result of the provision of one deformation sensor per detent, a deformation of the first ring on each detent can be detected. A separate statement relating to the drive force transmitted per detent is thereby possible. A statement for each detent relating to a torque transmitted at that location is also thereby possible. The sensor apparatus may be configured to separately detect the drive force transmitted at each detent. For example, as a result of the associated deformation measurements per detent, shape tolerances in shafts, tooth arrangements and the detents or tolerances in a concentricity of components of the drive arrangement can be compensated for in order to be able to measure respective operating variables in a particularly precise manner. Such tolerances and respective individual deviations in individual drive arrangements as a result of production tolerances and assembly tolerances may bring about a non-uniform engagement of the detents with the tooth arrangement. The detents can thereby transmit different amounts of force and also be loaded to different extents. Even with no tolerance deviations, loads prevailing in the drive arrangement may deform components and detents may thereby be loaded to differing degrees. These deviations which with each detent can also deform the first ring to a different extent may also be dependent on a relative rotation position of the two rings with respect to each other.

As a result of the provision of one deformation sensor per detent, however, these effects can be partially or even completely compensated for by the sensor apparatus. The sensor apparatus may, for example, be configured to detect how much load is transmitted by each detent. The deformation sensors may produce an associated measurement value for each individual detent. New evaluation possibilities are also thereby provided, which will be explained below.

The deformation sensors may be secured to the first ring. The deformation sensors may be arranged spaced apart from each other in a uniform manner in a circumferential direction. The deformation sensors may be arranged with a uniform extent on the first ring or with a uniform radial spacing with respect to a rotation axis. The deformation sensors may, for example, be arranged axially at the height of the detent freewheel mechanism. The sensor apparatus may, for example, be configured to determine the deformation in an electro-resistive, magnetic, optical or also acoustic manner. For example, the sensor apparatus may have a plurality of wire strain gauges which are secured to the first ring as deformation sensors. Alternatively, for example, Hall sensors can also be used. The sensor apparatus may have an evaluation apparatus in order to evaluate respective sensor signals. The detents may be spaced apart from each other in a uniform manner in a circumferential direction. The detents may, for example, be arranged symmetrically on the first ring. The deformation sensors may be arranged symmetrically on the first ring. All the deformation sensors may be arranged identically relative to the associated detent. For example, each deformation sensor may have an identical radial spacing and identical spacing in a circumferential direction with respect to the associated detent thereof.

The first ring is, for example, connected to the foot pedal shaft in a rotationally secure manner. For example, the first ring and the foot pedal shaft may be configured in an integral manner. The sensor apparatus may be configured to detect a bending of the first ring and alternatively or additionally a bending of the foot pedal shaft. The deformation sensors may thus detect a bending of the foot pedal shaft during operation of the drive arrangement.

The second ring may have a continuous tooth arrangement in a circumferential direction. An engagement can thereby be ensured in a particularly rapid manner and, for example, already at a small rotation angle in the blocking direction. In addition, the second ring may thus be simple to produce. For example, the tooth arrangement may be formed by a covering face of the second ring. The tooth arrangement may, for example, be arranged radially at the inner side or radially at the outer side.

In one example embodiment of the drive arrangement, there may be provision for the first ring to be in the form of an inner ring and the second ring to be in the form of an outer ring. The second ring may be arranged radially at the outer side with respect to the first ring. The tooth arrangement may then be arranged radially at the inner side on the second ring. The production may then be particularly cost-effective and simple. In addition, respective sensors can thus be fitted in a simple manner to the first ring. The respective detents may, for example, be supported radially at the outer side on the first ring.

In one example embodiment of the drive arrangement, there may be provision for the first ring to be in the form of an outer ring and the second ring is in the form of an inner ring. The second ring may be arranged radially at the inner side with respect to the first ring. The tooth arrangement may then be arranged radially at the outer side on the second ring. The respective detents may, for example, be supported radially at the inner side on the first ring. The assembly of the detents may thereby be simplified.

In one example embodiment of the drive arrangement, there may be provision for each deformation sensor to be arranged adjacent to the associated detent on the first ring. For example, each of the deformation sensors may be arranged in the same circumferential region and alternatively or additionally with the same radial spacing from the rotation axis as the associated detent. A circumferential region may be defined, for example, in the circumferential direction between the rotation axis and opposing ends of a detent or a pocket in which the detent is arranged. The deformation sensors may also be arranged radially at the inner side or radially at the outer side relative to the detents. In the case of an adjacent arrangement, the measurement region of the sensors may be located as close as possible to or even on the associated detent. The deformation sensors may also be arranged in the circumferential direction and alternatively or additionally in the radial direction offset with respect to the associated detent.

In one example embodiment of the drive arrangement, there may be provision for the first ring to have a recess in each case in circumferential regions between adjacent detents. Alternatively or additionally, the first ring may have a recess in each case in circumferential regions between adjacent deformation sensors. For example, between adjacent detents a free space may be provided in the circumferential direction at least with the same radial spacing as the detents with respect to the rotation axis. As a result of the recess, a force path between different detents and consequently also the associated deformation sensors thereof can be avoided. An influence of other detents and the force transmitted at that location to one of the detents can thereby be reduced or even completely prevented. Each deformation sensor can thereby detect a deformation which corresponds in a particularly precise manner to the force applied at the associated detent. As a result of a spatial separation based on respective recesses, respective detent loads can thus be detected in a particularly precise manner without this detection being influenced by other detent loads.

In one example embodiment of the drive arrangement, there may be provision for each deformation sensor to be arranged on the first ring in the circumferential direction behind the associated detent in a direction of a force acting from the respective detent on the first ring. A detent may, for example, have a first end which is in engagement with the tooth arrangement in the blocking state of the detent freewheel mechanism. A detent may have a second end which is, for example, opposite the first end. This second end is supported, for example, in the blocking state on the first ring, for example, in an associated pocket. This second end may be rotatably supported on the first ring. A vector directed from the first end to the second end may correspond to the direction of the force acting from the respective detent on the first ring. A circumferential direction portion of this vector may correspond to the direction in which each deformation sensor is arranged behind the associated direction. The measurement region can thus be particularly well located in a force transmission path and the detected deformation may thus be a particularly advantageous measurement variable.

In one example embodiment of the drive arrangement, there may be provision for at least one of the detents to be in the form of a dual detent. For example, all the detents may be in the form of dual detents. A dual detent may, for example have two detent elements which are separate. A dual detent may, for example, also have two tips which are located one behind the other in a circumferential direction. Such detents may engage at more than one location and, for example, transmit a load at two locations. The detent elements may, for example, all engage with the tooth arrangement in the blocking state of the detent freewheel. The two detent elements may be arranged one behind the other in an axial direction but in the same circumferential region and in the same radial region. A dual detent may be configured in an integral manner and, for example, have two engagement regions. A dual detent may have the same rotation axis for each detent element, alternatively or additionally a common pocket. The two detent elements may use the same bearing on the first ring. Only one associated deformation sensor may be provided per dual detent. One deformation sensor per dual detent may also be arranged axially at both sides on the first ring. One associated deformation sensor may also be provided per detent element. As a result of dual detents, the detent freewheel mechanism may be cost-effective and compact and nonetheless transmit high loads. Triple detents or detents with more than three detent elements may also be provided. The above statements relating to the dual detent apply in a similar manner in this instance. A normal detent may, for example, have only one detent element. For example, all the detents may be in the form of normal detents.

In one example embodiment of the drive arrangement, there may be provision for the drive arrangement to have an evaluation apparatus which is configured to evaluate the deformations of the first ring as detected by the deformation sensors. The evaluation apparatus may have a microprocessor. As a result of the evaluation, a force which is generally applied can, for example, be calculated. As a result of the evaluation, a load applied to each individual detent can also be calculated. The evaluation may, for example, be carried out by a tabular comparison, an analytical calculation or a previously trained neural network. As a result of the evaluation, for example, disturbance variables can also be calculated.

In one example embodiment of the drive arrangement, there may be provision for the evaluation apparatus to be configured to determine a pedalling behaviour of a rider in accordance with the deformations of the first ring as detected by the deformation sensors. A pedalling behaviour may, for example, have a pedalling frequency. A pedalling behaviour may have a drive force which is introduced over time. A pedalling behaviour may have an information item as to whether the rider is standing or seated when pedalling. For example, it can be identified whether the rider is pedalling when standing or when seated since in this instance a loading and consequently the deformation of the foot pedal shaft changes. The pedalling behaviour may, for example, be indicated or be used in order to control a drive motor. As a result of the detection of the deformation in the region of each detent, a bending of the foot pedal shaft and a torque which is introduced can be identified.

For example, a non-circular pedalling action can be identified and the rider can be given a notification or correction suggestions. The capacity of the rider can thereby be optimised. Medical problems resulting from bicycle riding can thus also be prevented. For example, a support stage of the drive motor can be adapted in accordance with the determined pedalling behaviour. A type of support within a rotation depending on the determined pedalling behaviour can also be controlled. For example, the drive motor can be controlled for a dead centre compensation when pedalling. As a result of the dead centre compensation, an additional drive force can be provided by the drive motor when respective pedals are fully at the top and fully at the bottom and the rider can then, for example, not introduce any torque. The control and the output can be carried out by the evaluation apparatus. For the output, an output apparatus may also be provided. This may, for example, have a screen and alternatively or additionally transmit corresponding data, for example, to a smartphone. For the control there may also be provided a control apparatus which controls the drive motor. The control apparatus may, for example have an inverter which controls a power supply of a drive motor which is in the form of an electric motor.

In one example embodiment of the drive arrangement, there may be provision for the evaluation apparatus to be configured to determine an engagement behaviour of the detent freewheel mechanism in accordance with the deformations of the first ring as detected by the deformation sensors. The engagement behaviour may, for example, contain information as to how far and alternatively or additionally how well each detent is in engagement with the tooth arrangement. The engagement behaviour may have an associated drive force which is transmitted via each detent.

Errors in the detent freewheel mechanism can thus be identified. For example, the detents, the tooth arrangement or the first ring with pockets may be subject to tolerances in terms of their shape. Respective components may also not rest completely concentrically or parallel. This may be a result of production errors or assembly errors and the appearances of wear of the components up to defects. When the detents do not always transmit the same amount of force relative to each other depending on the engagement position of the detent freewheel mechanism, this can be identified by the evaluation apparatus. These information items can form a portion of the determined engagement behaviour. With respect to the determined engagement behaviour, respective deformation signals can be corrected and alternatively or additionally disturbance variables can be compensated for and the torque applied can thus be established very precisely. Using information relating to production or assembly errors, it is additionally possible, for example, for the manufacturer to carry out a quality control on the production line. The evaluation apparatus may identify errors in the production and assembly by the deformation sensors associated with the detents as part of the determined engagement behaviour. Using information relating to wear and defects, a maintenance operation up to a replacement can further be planned, for example, in the context of predictive maintenance.

In one example embodiment of the drive arrangement, there may be provision for the evaluation apparatus to be configured to identify damaged teeth of the tooth arrangement of the second ring on the basis of the engagement behaviour. Alternatively or additionally, the evaluation apparatus may be configured to identify damaged detents on the basis of the engagement behaviour. The drive arrangement may have a drive motor and a control apparatus. The control apparatus may be configured to control the drive motor in order to avoid engagement of the detents with teeth which have been identified as being damaged. For example, in the case of engagement of the detents with the tooth arrangement or when the detent freewheel mechanism changes into the blocked state, it can be identified whether the detents are in engagement with one or more damaged teeth. By driving with the drive motor, an engagement position can then be changed, for example, with a temporary change into the release state. Alternatively or additionally, a position of damaged teeth can be stored and in principle a change into the blocking state at such a position can be prevented, for example, by corresponding control of the drive motor. In this instance, a position sensor may be provided for a relative position of the two rings. As a result of a limited number of teeth of the tooth arrangement, there is a limited number of engagement positions. Over a relatively long period of time, respective measurement values of the engagement behaviour can be stored and compared. If a tooth is then damaged, this can be identified with reference to respective loading behaviours, which are known over the period of time, of the detents. In this instance, for example, the drive motor may briefly accelerate one of the rings beyond a crank speed of the rider. The detent freewheel mechanism thereby briefly disengages. As soon as the speed of the drive motor adjusts to a speed of the foot pedal shaft again, the detent freewheel mechanism changes into the blocking state again. As a result of this control, an engagement position in which the damaged tooth is no longer in engagement with the detent can be displaced. Consequently, a complete failure and consequential damage can be avoided. The detent freewheel mechanism can consequently have a longer service life.

A second example aspect relates to a method for operating a drive arrangement according to the first aspect. Respective advantages and other features can be taken from the description of the first example aspect, wherein embodiments of the first example aspect also form embodiments of the second example aspect and vice versa. The method includes detecting a deformation of the first ring of the detent freewheel mechanism for each detent with the associated deformation sensor. The method additionally includes evaluating the detected deformations of the first ring. For example, a drive force which is applied or a transmitted torque can be determined by the evaluation. An engagement behaviour and alternatively or additionally a pedalling behaviour can also be determined.

In one example embodiment of the method, there may be provision for a determination of a pedalling behaviour of the rider to be carried out in accordance with the detected deformations of the first ring. In addition, the method may include outputting the determined pedalling behaviour to the rider. The rider can thereby control his/her pedalling behaviour. For example, the rider can be shown a graph with his/her introduced drive force over time. Alternatively or additionally, a determination of proposed changes to the pedalling behaviour and output of the proposed changes to the rider can be carried out. Tips for a more rounded pedalling action and more efficient use of the bicycle can, for example, be given to the rider. Alternatively or additionally, a control of the drive motor of the drive arrangement can be carried out in accordance with the determined pedalling behaviour. For example, a change of a support stage can be carried out or a supporting drive force within a rotation of the foot pedal shaft can be varied, for example, in order to compensate for a dead centre. The control of the drive motor of the drive arrangement depending on the determined pedalling behaviour can in this instance be superimposed with control of the drive motor depending on the determined drive force applied or the determined torque transmitted, for example, by displacing a control characteristic line.

In one example embodiment of the method, there may be provision for a determination of an engagement behaviour of the detent freewheel mechanism to be carried out in accordance with the detected deformations of the first ring. In addition, the method may include determining a torque transmitted by the detent freewheel mechanism in accordance with the determined engagement behaviour. For example, detected deformation values can be modified in accordance with the determined engagement behaviour and the torque transmitted by the detent freewheel mechanism can be determined on the basis of the modified deformation values. Alternatively or additionally, a determination of assembly errors in the detent freewheel mechanism may be carried out in accordance with the determined engagement behaviour. Alternatively or additionally, production errors in the detent freewheel mechanism can be determined in accordance with the determined engagement behaviour. The production errors and assembly errors may be indicated for quality control, for example, as a generic error message or also with information items relating to a type of the error specifically present. Alternatively or additionally, a maintenance prediction for the detent freewheel mechanism can be determined in accordance with the determined engagement behaviour. For example, it can be calculated when the second ring of the detent freewheel mechanism or the detent freewheel mechanism is generally intended to be replaced. This prediction may, for example, be output as a remaining time for use or remaining running power. Alternative or additionally, an identification of damaged teeth of the tooth arrangement of the second ring and control of the drive motor of the drive arrangement can be carried out in order to avoid engagement of the detents with teeth which have been identified as being damaged.

A third example aspect relates to a bicycle having a drive arrangement according to the first example aspect and an output element. The output element may, for example, be a rear running wheel of the bicycle. The output element may be able to be driven by the drive arrangement, for example, when the detent freewheel mechanism is in the blocked state thereof. The drive arrangement can be operated with the method according to the second example aspect. Respective advantages and other features can be derived from the description of the first or second example aspect, wherein embodiments of the first and second example aspect also form embodiments of the third example aspect and vice versa.

### BRIEF DESCRIPTION OF THE FIGURES

FIG. 1 shows an installation situation of a drive arrangement with a detent freewheel mechanism in a bicycle.

FIG. 2 shows a first example embodiment of a detent freewheel mechanism of the drive arrangement according to FIG. 1 as a schematic side view along a rotation axis of the detent freewheel mechanism.

FIG. 3 shows a second example embodiment of a detent freewheel mechanism of the drive arrangement according to FIG. 1 as a schematic side view along a rotation axis of the detent freewheel mechanism.

FIG. 4 shows the detent freewheel mechanism according to FIG. 3 as a schematic perspective view.

FIG. 5 shows a method for operating the drive arrangement according to FIG. 1.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

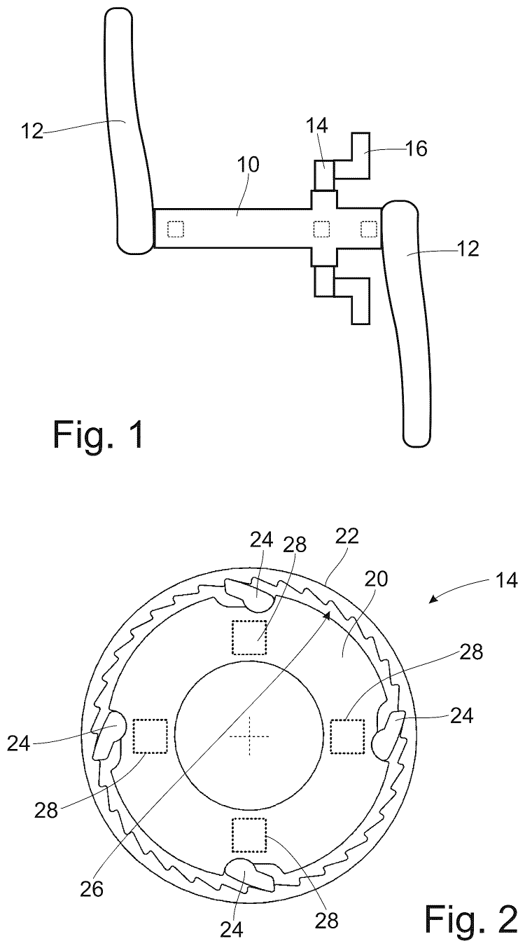

FIG. 1 schematically shows an installation of a drive arrangement in a bicycle. The drive arrangement has a foot pedal shaft 10 with foot pedal arms 12 which are secured thereto at both sides in a rotationally secure manner. A pedal which is not illustrated is rotatably secured in each case to the foot pedal arms 12. The drive arrangement further has a detent freewheel mechanism 14 and an output shaft 16 with a pinion. The detent freewheel mechanism 14 may change independently between a blocking state, in which the detent freewheel mechanism 14 connects the foot pedal shaft 10 to the output shaft 16 in a rotationally secure manner, and a release state, in which the foot pedal shaft 10 can rotate relative to the output shaft 16, depending on a relative rotation direction of the foot pedal shaft 10 and the output shaft 16 with respect to each other. In the blocking state, a torque can accordingly be transmitted by the detent freewheel mechanism 14.

The drive arrangement has a sensor apparatus which is configured to detect a deformation of a component of the detent freewheel mechanism 14. Based on this deformation, a drive force which is introduced by the rider at the foot pedal shaft 10 is determined.

A first example embodiment of the detent freewheel mechanism 14 is illustrated as a schematic side view in FIG. 2. The detent freewheel mechanism 14 has a first ring 20 which is in the form of an inner ring. The first ring 20 forms a disc which is permanently connected to the foot pedal shaft 10 in a rotationally secure manner. A second ring 22 is arranged coaxially and radially at the outer side relative to the first ring 20. The second ring 22 is permanently connected to the output shaft 16 in a rotationally secure manner. On the first ring 20, four detents 24 are movably supported radially at the outer side. The second ring 22 has a tooth arrangement 26 which extends radially at the inner side and which faces the detents 24. The tooth arrangement 26 is configured for engagement with the detents 24. FIG. 2 shows the detent freewheel mechanism 14 in a blocking state, in which the detents 24 are in engagement with the tooth arrangement 26. Accordingly, a torque can be transmitted from the first ring 20 to the second ring 22 as a result of a drive force acting on the foot pedal 10.

Furthermore, FIG. 2 shows four deformation sensors 28 of the sensor apparatus. One of the detents 24 is associated with each deformation sensor 28. The deformation sensors 28 are adhesively bonded at the end face to the first ring 20 and are in the form of wire strain gauges. Each deformation sensor 28 is arranged radially at the inner side with respect to the associated detent 24 in the same circumferential region as the associated detent 24 adjacent to the associated detent 24. Accordingly, the sensor apparatus detects an isolated measurement value of a deformation for each individual detent 24 from which it can be concluded how much load there is in each case applied to this detent 24. Disturbance variables, for example, caused by reaction forces on the detents 24 and a bending of the foot pedal shaft 10 under load can thereby be calculated and a drive force which is actually applied can be determined in a very precise manner.

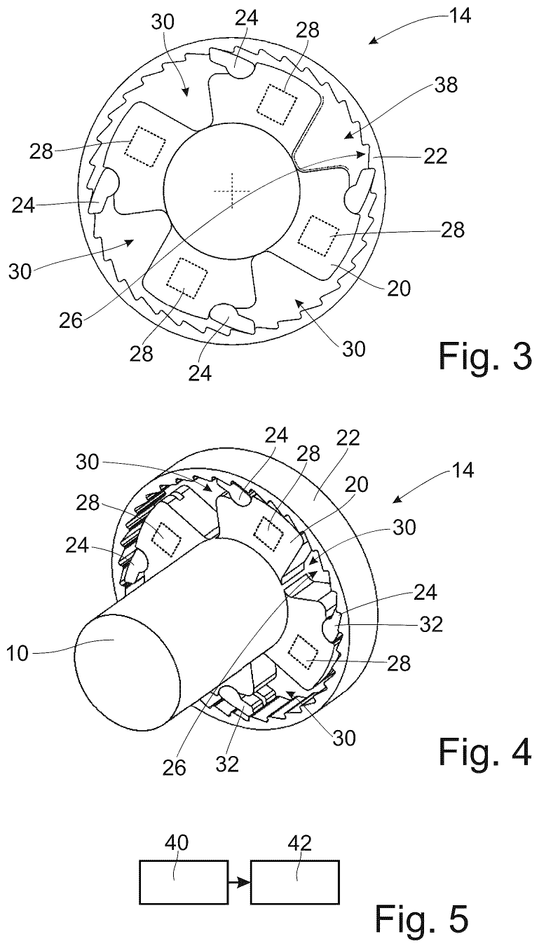

FIG. 3 shows a second example embodiment of the detent freewheel mechanism 14. Only differences with respect to the first embodiment will be described below. In the second example embodiment, the first ring 20 has in each case in the circumferential region between adjacent detents 24 a recess 30. These recesses 30 are in the form of radially inwardly protruding wedge-like free spaces on which the disc of the first ring 20 is interrupted. In other example embodiments, the recesses 30 are formed differently. As a result of the recesses 30, the regions of the first ring 20 to which the deformation sensors 28 are secured, are in each case spatially separated from each other in a circumferential direction. A deformation and consequently also a deformation measurement carried out adjacent to each detent 24 by the associated deformation sensor 28 in each case is not thereby influenced or at least to a lesser extent by a detent load on the remaining detents 24.

In the second example embodiment, the deformation sensors 28 are no longer arranged in the same circumferential region as the associated detent 24 in each case. Instead, each deformation sensor 28 is arranged in the circumferential direction on the first ring 20 behind the associated detent 24 in a direction of a force acting from the respective detent 24 on the first ring 20. The direction is produced in this instance by a circumferential portion of a vector which extends from one end of each detent 24 which engages with the tooth arrangement 26 to an end of each detent 24 which rests on the first ring 20 and is rotatably supported on the first ring 20.

In the first example embodiment, the detents 24 are in the form of single detents, that is to say, with one detent element. In the schematic perspective view of the second example embodiment in FIG. 4, it can be seen that the detents 24 of the second example embodiment of the detent freewheel mechanism 14 have a central gap which extends in the circumferential direction. In this gap, there is arranged an annular spring which presses all the detent elements 32 together into engagement.

FIG. 5 shows a method for operating the drive arrangement. In a first step 40, a deformation of the first ring 20 of the detent freewheel mechanism 14 is detected for each detent 24 with the associated deformation sensor 28. In a second step 42, there is an evaluation of the detected deformations of the first ring 20. In one example embodiment of the method, the drive force applied to the detent freewheel mechanism 14 is thus established. In another example embodiment of the method, alternatively or additionally a pedalling behaviour of the rider is established in accordance with the detected deformations of the first ring 20. This pedalling behaviour is output to the rider. Alternatively or additionally, change proposals for the pedalling behaviour are determined and these change proposals are output to the rider. Alternatively or additionally, a control of a drive motor of the drive arrangement is carried out in accordance with the determined pedalling behaviour. In another example embodiment of the method, alternatively or additionally, an engagement behaviour of the detent freewheel mechanism 14 is determined in accordance with the detected deformations of the first ring 20. In accordance with the engagement behaviour, assembly errors and production errors are determined and output. Alternatively or additionally, a maintenance prediction for the detent freewheel mechanism 14 is produced in accordance with the determined engagement behaviour. Alternatively or additionally, an identification of damaged teeth of the tooth arrangement 26 of the second ring 22 is carried out and a control of the drive motor of the drive arrangement, if present, in order to avoid engagement of the detents 24 with teeth which are identified as being damaged.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### LIST OF REFERENCE NUMERALS

10 Foot pedal shaft
12 Foot pedal arms
14 Detent freewheel mechanism
16 Output shaft
20 First ring
22 Second ring
24 Detent
26 Tooth arrangement
28 Deformation sensor
30 Recess
32 Detent element
40 Detecting a deformation of the first ring
42 Evaluating the detected deformations of the first ring

1-14. (canceled)

15. A drive arrangement for a bicycle, comprising:
a detent freewheel mechanism (14) that includes a first ring (20) with detents (24) movably supported on the first ring (20) and also includes a second ring (22) with a tooth arrangement (26); and
a sensor apparatus configured to detect deformation of the first ring (20) of the detent freewheel mechanism (14) on the basis of a drive force which is applied, the sensor apparatus comprising a respective deformation sensor (28) for each detent (24).

16. The drive arrangement of claim 14, wherein the first ring (20) forms an inner ring, and the second ring (22) forms an outer ring.

17. The drive arrangement of claim 14, wherein the first ring (20) forms an outer ring, and the second ring (22) forms an inner ring.

18. The drive arrangement of claim 14, wherein each deformation sensor (28) is arranged adjacent the respective detent (24) on the first ring (20).

19. The drive arrangement of claim 14, wherein the first ring (20) comprises a plurality of recesses (30), each recess of the plurality of recesses (30) disposed in a respective circumferential region between a respective pair of adjacent detents (24).

20. The drive arrangement of claim 14, wherein each deformation sensor (28) is arranged on the first ring (20) in a circumferential direction behind the respective detent (24) in a direction of a force acting from the respective detent (24) on the first ring (20).

21. The drive arrangement of claim 14, wherein the drive arrangement comprises an evaluator computing device configured to evaluate the deformations of the first ring (20) as detected by the deformation sensors (28).

22. The drive arrangement of claim 21, wherein the evaluator computing device is configured to determine a pedaling behavior of a rider in accordance with the deformation of the first ring (20) as detected by the deformation sensors (28).

23. The drive arrangement of claim 21, wherein the evaluator computing device is configured to determine an engagement behavior of the detent freewheel mechanism (14) in accordance with the deformations of the first ring (20) as detected by the deformation sensors (28).

24. The drive arrangement of claim 23, wherein:
the evaluator computing device is configured to identify damaged teeth of the tooth arrangement (26) of the second ring (22) on the basis of the engagement behaviour;
the drive arrangement further comprises a drive motor and a controller; and
the controller is configured to control the drive motor in order to avoid engagement of the detents (24) with teeth which have been identified as being damaged.

25. A method for operating the drive arrangement of claim 14, the method comprising:
detecting (40) deformation of the first ring (20) of the detent freewheel mechanism (14) for each detent (24) with the associated deformation sensor (28); and
evaluating (42) the detected deformations of the first ring (20).

26. The method of claim 25, further comprising:
determining a pedaling behavior of the rider in accordance with the detected deformations of the first ring (20); and
one or more of the following
outputting the determined pedaling behavior to the rider,
determining proposed changes for the pedaling behavior and outputting the proposed changes to the rider, and
controlling a drive motor of the drive arrangement in accordance with the determined pedaling behavior.

27. The method of claim 25, further comprising:
determining an engagement behavior of the detent freewheel mechanism (14) in accordance with the detected deformations of the first ring (20); and
one or more of the following
determining a torque transmitted by the detent freewheel mechanism (14) in accordance with the determined engagement behavior,
determining assembly errors in the detent freewheel mechanism (14) in accordance with the determined engagement behavior,
determining production errors in the detent freewheel mechanism (14) in accordance with the determined engagement behavior,
producing a maintenance prediction for the detent freewheel mechanism (14) in accordance with the determined engagement behavior, and
identifying damaged teeth of the tooth arrangement (26) of the second ring (22) and controlling a drive motor of the drive arrangement in order to avoid engagement of the detents (24) with teeth which have been identified as being damaged.

14. A bicycle, comprising:
a drive arrangement of claim 14; and
an output element configured to be driven by the drive arrangement.
